(19) United States
(12) Patent Application Publication
(10) Pub. No.: US 2008/0126585 A1
(43) Pub. Date: May 29, 2008

(54) RADIO COMMUNICATION APPARATUS, RADIO COMMUNICATION SYSTEM, AND COMMUNICATION QUALITY DISPLAY METHOD FOR RADIO COMMUNICATION APPARATUS

(75) Inventor: Masafumi Matsumura, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 11/942,609

(22) Filed: Nov. 19, 2007

(30) Foreign Application Priority Data
Nov. 29, 2006 (JP) 2006-322279

(51) Int. Cl. G06F 3/00

(52) U.S. Cl. 710/8

(57) ABSTRACT

According to one embodiment, a radio communication apparatus includes: a radio communication device for assigning communication times to a plurality of peripheral devices and performing data communication by radio with one or more other communication apparatuses on a time-division basis; a communication quality judging device for judging a communication quality for each of the peripheral devices in the data communication performed by the radio communication device with the other communication apparatuses; and a display controlling device for displaying an interface image indicating the communication quality of each of the peripheral devices according to the communication quality judged by the communication quality judging device.

### CROSS-REFERENCE TO RELATED APPLICATIONS

This application is based upon and claims the benefit of priority from Japanese Patent Application No. 2006-322279, filed Nov. 29, 2006, the entire contents of which are incorporated herein by reference.

### BACKGROUND

1. Field

One embodiment of the invention relates to a radio communication apparatus, a radio communication system, and a communication quality display method for a radio communication apparatus.

2. Description of the Related Art

In recent years, personal computers are in widespread use. The recent personal computer may operate as a radio communication apparatus including a radio communication function. When such a personal computer is operated as a radio communication apparatus, the personal computer is operating while performing data communication with peripheral devices such as a display device such as an external monitor, an optical device such as a DVD drive or a CD drive, a sound source reproducing device such as a speaker, and an input device such as a mouse or a keyboard.

However, if the personal computer is located apart from the peripheral devices in this event, the communication quality determined, for example, by BER (bit error rate) will be degraded. In this regard, a radio communication apparatus which displays in symbol the communication quality in a one-to-one radio communication based on the measured transmission speed is described in Patent Document 1, JP 2005-151585.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary view showing a configuration of a radio communication system according to a first embodiment of the invention;

FIG. 2 is an exemplary block diagram showing a configuration of a radio communication apparatus in the first embodiment;

FIG. 3 is an exemplary illustration showing a first table in which a radio wave intensity is associated with a target transfer rate in the first embodiment;

FIG. 4 is an exemplary illustration showing a second table in which a lower limit transfer rate is associated with an upper limit interval for each of peripheral devices in the first embodiment;

FIG. 5 is an exemplary illustration showing communication data which has been subjected to data assignment for each of the peripheral devices according to a TDMA system in the first embodiment;

FIG. 6 is an exemplary view showing interface images according to the communication qualities in the first embodiment;

FIG. 7 is an exemplary flowchart showing a communication quality display processing of the radio communication apparatus in the first embodiment;

FIG. 8 is an exemplary block diagram showing a configuration of a radio communication apparatus in a second embodiment;

FIG. 9 is an exemplary view showing a window image on a liquid crystal display when designating a priority for each of the peripheral devices in the second embodiment;

FIG. 10 is an exemplary flowchart showing the communication quality display processing of the radio communication apparatus in the second embodiment;

FIG. 11 is an exemplary view showing a configuration of a radio communication system according to a modification example of the invention;

FIG. 12 is an exemplary illustration showing communication data which has been subjected to data assignment for each of peripheral devices according to the TDMA system in the modification example;

FIG. 13 is an exemplary view showing interface images according to the communication qualities in the modification example; and

FIG. 14 is an exemplary view showing a window image on the liquid crystal display when designating the priority for each of the peripheral devices in the modification example.

### DETAILED DESCRIPTION

Various embodiments according to the invention will be described hereinafter with reference to the accompanying drawings. In general, according to one embodiment of the invention, a radio communication apparatus includes: a radio communication device for assigning communication times to a plurality of peripheral devices and performing data communication by radio with one or more other communication apparatuses on a time-division basis; a communication quality judging device for judging a communication quality for each of the peripheral devices in the data communication performed by the radio communication device with the other communication apparatuses; and a display controlling device for displaying an interface image indicating the communication quality of each of the peripheral devices according to the communication quality judged by the communication quality judging device.

Further, a radio communication system includes: the above-described radio communication apparatus; and another communication apparatus for performing data communication relating to a plurality of peripheral devices, with the radio communication apparatus.

Further, a communication quality display method for a radio communication apparatus includes: judging a communication quality for each of peripheral devices in data communication performed by a radio communication device with one or more communication apparatuses, the radio communication device assigning communication times to a plurality of peripheral devices and performing data communication by radio with the other communication apparatuses on a time-division basis; and displaying an interface image indicating the communication quality of each of the peripheral devices according to the judged communication quality.

### First Embodiment

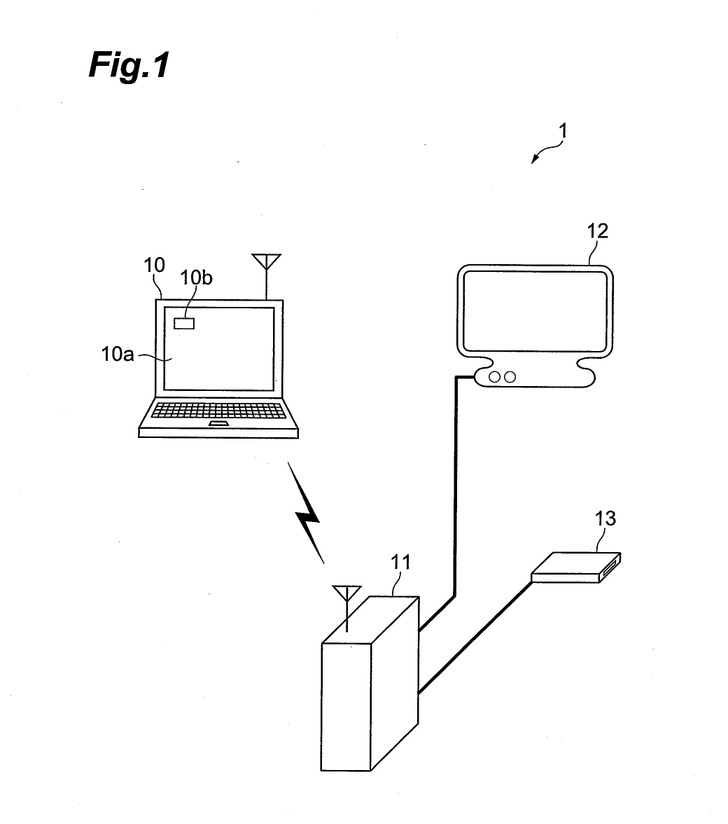

FIG. 1 is a view showing a configuration of a radio communication system according to a first embodiment of the invention. A radio communication system 1 shown in FIG. 1 comprises a radio communication apparatus 10, a HUB device 11, a display device 12, and an optical device 13.

The radio communication apparatus 10 is, for example, a personal computer. The radio communication apparatus 10 is a device comprising a radio communication function to perform data communication relating to the display device 12 and the optical device 13, which are peripheral devices, with the HUB device 11 which is a communication apparatus on a single communication time base using a TDMA system.

The HUB device 11 performs data communication by radio with the radio communication apparatus 10 on an interface standard such as a wireless USB (Universal Serial Bus). To the HUB device 11, the display device 12 is connected via a cable conforming to an interface standard such as DVI (Digital Visual Interface) or HDMI (High Definition Multimedia Interface), and the optical device 13 is connected via a cable conforming to the interface standard such as USB. To the HUB device 11, a not-shown sound source reproducing device or input device can be connected. The HUB device 11 is, for example, a wireless docking station which communicates with the radio communication apparatus 10 by radio to expand the function of the radio communication apparatus 10 that is a personal computer, and can logically connect the peripheral devices, which are connected to the HUB device 11 via the USB cable, the DVI cable or the like, to the personal computer.

The display device 12 is, for example, a CRT monitor or a liquid crystal display.

The optical device 13 is, for example, a DVD drive, a CD drive or the like. Though not shown, examples of the sound source reproducing device include a speaker and so on, and examples of the input device include, for example, a mouse, a keyboard, and so on.

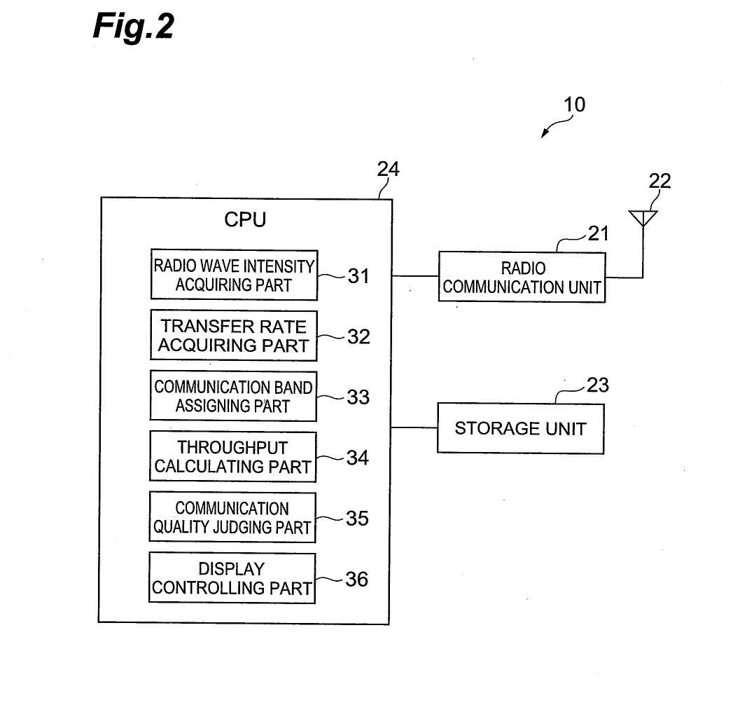

Next, the radio communication apparatus 10 will be described in detail. FIG. 2 is a block diagram showing a configuration of the radio communication apparatus 10. The radio communication apparatus 10 comprises a radio communication unit 21, an antenna 22, a storage unit (first and second transfer rate storage device) 23, and a CPU (Central Processing Unit) 24.

The radio communication unit 21 is used to perform radio data communication by radio with the HUB device 11 via the antenna 22 and is, for example, a UWB (Ultra Wideband) communication I/F, a millimeter-wave communication I/F or the like.

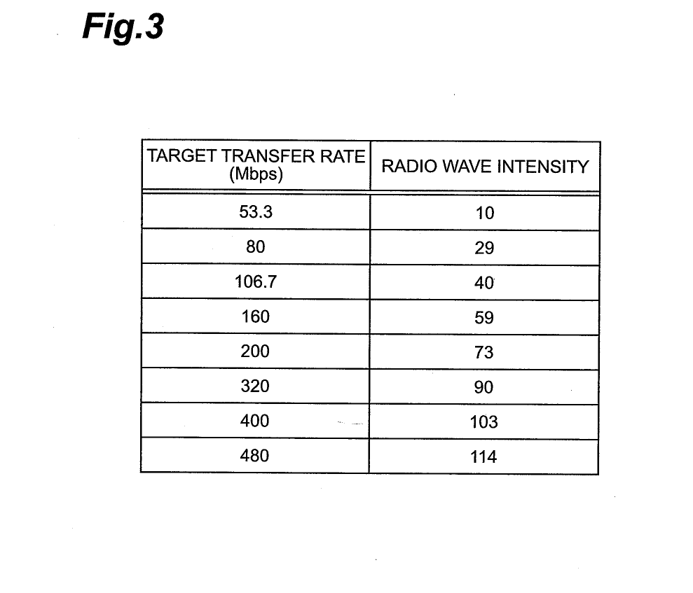

The storage unit 23 is, for example, a ROM (Read Only Memory), a RAM (Random Access Memory), or an HDD (Hard Disk Drive), and has stored a first table, a second table, and a third table in advance. FIG. 3 is an illustration showing the first table. As shown in FIG. 3, the first table is a table in which an appropriate target transfer rate varying depending on the radio wave intensity (also referred to as a target data rate, target bit rate, or target band) is associated with each of radio field intensities. Although the first table shown in FIG. 3 is one example of a table for the optical device 13 as a DVD drive, the storage unit 23 also stores a first table in which numeral values have been set for the display device 12 though not shown. In other words, the storage unit 23 stores the first table for each of the peripheral devices such as the display device 12 and the optical device 13.

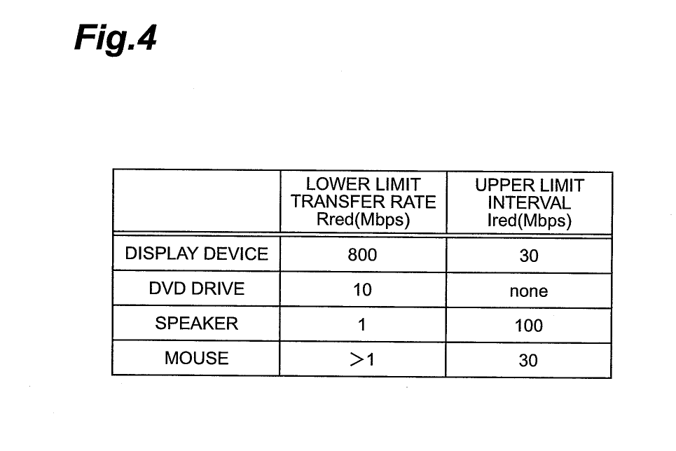

FIG. 4 is an illustration showing the second table. As shown in FIG. 4, the second table is a table in which a minimum transfer rate determined in accordance with the interface standard as a lower limit transfer rate Rred is associated with a minimum interval as an upper limit interval Ired for each of the peripheral devices. Note that in this embodiment, data for the speaker as the sound source reproducing device and the mouse as the input device which are possibly connected to the HUB device 11 have been stored in the second table in advance in addition to the data for the display device 12 and the DVD drive as the optical device 13.

Similarly, the third table, though not shown, is a table in which a margin transfer rate Rblue having a value larger than the lower limit transfer rate Rred to have a sufficient margin with respect to the lower limit transfer rate Rred is associated with a margin interval Iblue having a value smaller than the upper limit interval Ired to have a sufficient margin with respect to the upper limit interval Ired, for each of the peripheral devices. Note that the second table and the third table may be stored in the storage unit 23 as one table.

The CPU 24 loads various kinds of programs stored in the storage unit 23 to function as a radio wave intensity acquiring part (communication quality data acquiring device) 31, a transfer rate acquiring part 32, a communication band assigning part 33, a throughput calculating part 34, a communication quality judging part 35, and a display controlling part 36.

The radio wave intensity acquiring part 31 acquires the radio wave intensity in the data communication performed by the radio communication unit 21 for each of the peripheral devices such as the display device 12 and the optical device 13. In this embodiment, the radio wave intensity acquiring part 31 acquires the intensity of the radio wave received by the radio communication unit 21 from the HUB device 11.

The transfer rate acquiring part 32 acquires a target transfer rate Rmax corresponding to the radio wave intensity acquired by the radio wave intensity acquiring part 31 from the above-described first table for each of the peripheral devices.

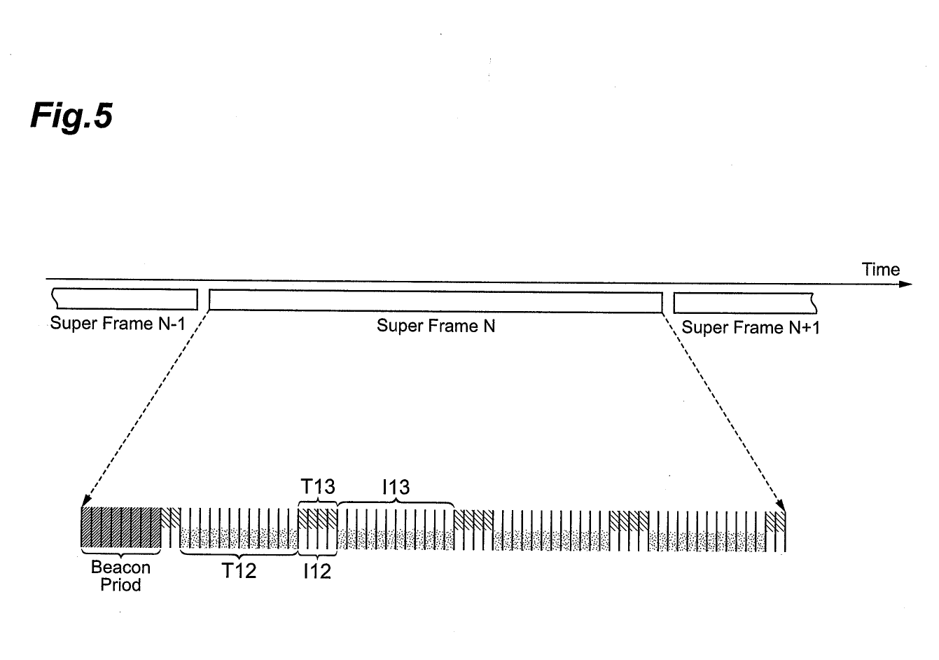

The communication band assigning part 33 assigns a communication time and an interval i for each of the peripheral devices according to the target transfer rate Rmax acquired by the transfer rate acquiring part 32. FIG. 5 is an illustration showing the communication data which has been subjected to data assignment for each of the peripheral devices according to the TDMA (Time Division Multiple Access) system. As shown in FIG. 5, the communication band assigning part 33 assigns a communication time T12 and an interval I12 for the display device 12, and a communication time T13 and an interval I13 for the optical device 13 in one super frame according to the respective target transfer rates Rmax. This allows the communication band assigning part 33 to assign the communication band (communication slot) when communicating using the TDMA system, to each of the peripheral devices.

The throughout calculating part 34 calculates the throughput for each of the peripheral devices based on the target transfer rate Rmax acquired by the transfer rate acquiring part 32 and the communication time assigned by the communication band assigning part 33. Specifically, the throughput calculating part 34 obtains a throughput r expected in the data communication with a peripheral device by the following throughput calculation expression.

r=Rmax×T1/T0
T0: time of 1 super frame
T1: total communication time assigned in 1 super frame

The communication quality judging part 35 compares the throughput r calculated by the throughput calculating part 34 to the lower limit transfer rate Rred in the second table and the margin transfer rate Rblue in the third table, and compares the interval i assigned by the communication band assigning part 33 to the upper limit interval Ired in the second table and the margin interval Iblue in the third table, to judge the communication quality for each peripheral device according to these comparison results.

The communication quality here means an index indicating whether the communication band necessary for the peripheral device can be secured or not, and is determined by values of BER (Bit error Rate) and PER (Packet Error Rate), the radio wave intensity, and the degree of interference between signals. In this embodiment, the communication quality shall be indicated by three states: a normal state in which a communication band allowing good communication without error can be secured; an attention-required state in which error sometimes occurs but a communication band allowing communication can be secured; and a communication impossible state in which a communication band is not secured due to frequent occurrence of errors to make communication impossible.

Specifically, the communication quality judging part 35 judges the throughput r to be in the normal state when r≧Rblue, judges it to be in the attention-required state when Rblue>r≧Rred, and judges it to be in the communication impossible state when r<Rred. Similarly, the communication quality judging part 35 judges the interval i to be in the normal state when i≦Iblue, judges it to be in the attention-required state when Iblue<i≦Ired, and judges it to be in the communication impossible state when i>Ired. The communication quality judging part 35 then judges the communication quality according to these judgment results, that is, judges the communication quality to be in the normal state when both the throughput r and the interval i assigned are in the normal states, judges the communication quality to be in the attention-required state when at least any one of them is in the attention-required state, and judges the communication quality to be in the communication impossible state when at least any one of them is in the communication impossible state.

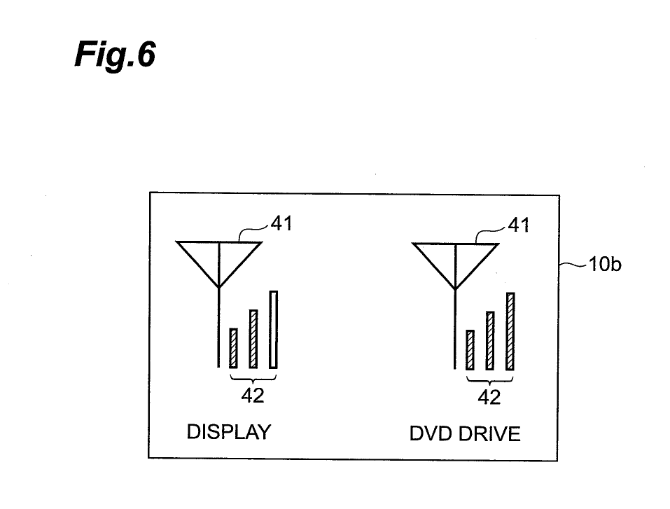

The display controlling part 36 displays interface images according to the communication qualities judged by the communication quality judging part 35 on the liquid crystal display 10a in a manner to separate them for each of the peripheral devices. FIG. 6 is a view showing one example of the interface images according to the communication qualities. As shown in FIG. 6, the interface image has an antenna 41 and radio wave intensity level bars 42 indicating the radio wave intensity to show the communication quality by the number of the radio wave intensity level bars 42 in this embodiment. For example, the display controlling part 36 displays the interface image of each of the peripheral devices on a display region 10b that is a part secured in the liquid crystal display 10a.

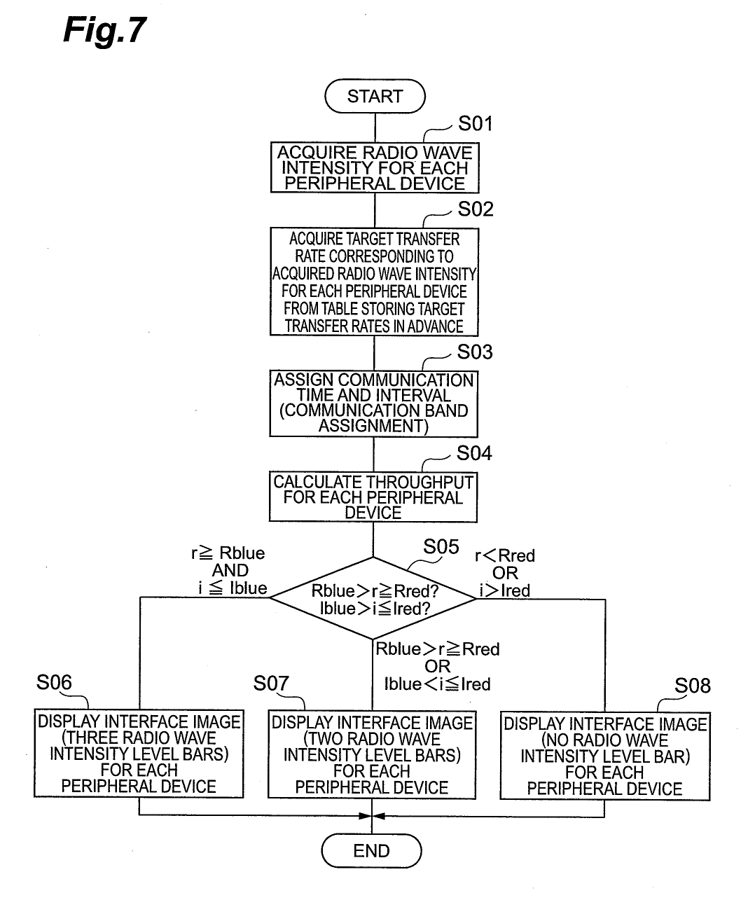

Next, the operation of the radio communication apparatus 10 will be described, and the communication quality display method for the radio communication apparatus according to the first embodiment of the invention will be described. FIG. 7 is a flowchart showing the communication quality display processing of the radio communication apparatus 10.

First, the CPU 24 in the radio communication apparatus 10 loads the various kinds of programs stored in the storage unit 23 to thereby function as the radio wave intensity acquiring part 31, the transfer rate acquiring part 32, the communication band assigning part 33, the throughput calculating part 34, the communication quality judging part 35, and the display controlling part 36.

The radio wave intensity acquiring part 31 acquires the radio wave intensity received from the HUB device 11 via the radio communication unit 21 and the antenna 22 as the radio wave intensities of the display device 12 and the optical device 13 (S01).

The transfer rate acquiring part 32 acquires the target transfer rate Rmax corresponding to the acquired radio wave intensity from the first table for each of the display device 12 and the optical device 13 (S02). This allows for judgment of the maximum data rate Rmax which can be supported in realizing the data communication by radio to each of the peripheral devices.

Next, the communication band assigning part 33 assigns the communication time and the interval i for each of the display device 12 and the optical device 13 according to the acquired target transfer rate Rmax. This allows the communication band assigning part 33 to assign the communication band to each of the display device 12 and the optical device 13 (S03).

The throughout calculating part 34 then calculates the throughput r for each of the display device 12 and the optical device 13 from the assigned communication time and the acquired target transfer rate Rmax (S04).

The communication quality judging part 35 then compares the calculated throughput r to the lower limit transfer rate Rred in the second table and the margin transfer rate Rblue in the third table, and compares the assigned interval i to the upper limit interval Ired in the second table and the margin interval Iblue in the third table, to judge the communication quality for each of the display device 12 and the optical device 13.

Specifically, the communication quality judging part 35 judges the throughput r to be in the normal state when r≧Rblue. The communication quality judging part 35 also judges it to be in the attention-required state when Rblue>r≧Rred, and judges it to be in the communication impossible state when r<Rred. Similarly, the communication quality judging part 35 judges the interval i to be in the normal state when i≦Iblue. The communication quality judging part 35 also judges it to be in the attention-required state when Iblue<i≦Ired, and judges it to be in the communication impossible state when i>Ired. The communication quality judging part 35 then judges the communication quality to be in the normal state when both the throughput r and the interval i assigned are in the normal states. The communication quality judging part 35 also judges the communication quality to be in the attention-required state when at least any one of them is in the attention-required state, and judges it to be in the communication impossible state when at least any one of them is in the communication impossible state (S05).

The display controlling part 36 displays interface images according to the judged communication states in the display region 10b on the liquid crystal display 10a in a manner to separate them for each of the display device 12 and the optical device 13. For example, the display controlling part 36 displays three radio wave intensity level bars 42 in black when the judged communication quality is in the normal state (S06), displays two radio wave intensity level bars 42 in black when the communication quality is in the attention-required state (S07), and displays one radio wave intensity level bar 42 in black when the communication quality is in the communication impossible state (S08).

Incidentally, the above-described communication band assigning part 33 assigns the communication time and interval necessary to operate each of the peripheral devices in consideration of each of the peripheral devices as will be described below in detail.

Since the maximum bit rate is about 10 Mbps when reproducing the DVD-Video whose specifications are designed by the DVD forum, the optical device 13 can reproduce video by setting the average transfer rate no less than about 10 Mbps. Thus, the communication time T13 assigned to the optical device 13 can be relatively flexibly set, and the communication band is relatively easily secured.

The input device transfers an overwhelmingly small amount of data than the optical device 13, but is often required to have good response. Thus, setting of the communication time to be assigned is slightly limited in the input device.

The conditions required for the sound source reproducing device are similar to those for the input device, in which no delay in reproduction of sound is permitted in a case such as during reproduction of video, and good response is required and the transfer data amount is larger than that of the input device. Accordingly, setting of the communication time to be assigned is limited in the sound source reproducing device.

On the other hand, the display device 12, in which the high-speed wired communication such as DVI and HDMI is made wireless, is required to be excellent both in band characteristics and response, and setting of the time T12 to be assigned is limited more than others.

In the radio communication apparatus 10, however, even if the assigned times T12 and T13 could be secured to meet the above-described requirements, a communication band necessary for each of the peripheral devices is not always ensured because the modulation system and the encoding rate for use might be different depending on the interface standard for each of the peripheral devices.

For example, when the modulation system is changed from QPSK (Quadrature Phase Shift Keying) to BPSK (Binary Phase Shift Keying), the data amount which can be transferred per unit time simply is reduced by half. The usable modulation system is limited to a modulation system having a maximum data rate of 480 Mbps for the specifications of the wireless USB, but wide variety of modulation systems can be selected for the radio transfer system by unique systems such as DVI and HDMI. In addition, there are many cases in which even if times required for the peripheral devices could be assigned according to the interface standard, communication should be performed after changing the modulation system into one immune to error because of a large distance between devices or occurrence of radio interference with other devices.

Thus, the data communication cannot always be realized with various peripheral devices which the use needs. In other words, a situation occurs in which some peripheral devices are usable but other peripheral devices are unusable.

Hence, according to the radio communication apparatus 10, the radio communication system 1, and the communication quality display method for the radio communication apparatus of the first embodiment, a target transfer rate Rmax required for the data communication is judged depending on the actually obtained radio wave intensity, a communication time and an interval i are assigned for each of the peripheral devices according to the target transfer rate Rmax to obtain an assigned throughput r. The throughput r is then compared to the lower limit transfer rate Rred necessary for the data communication stored in advance, and the assigned interval i is compared to the upper limit interval Ired necessary for the data communication stored in advance to judge the communication quality so that the interface image according to the communication quality is displayed for each peripheral device. This allows the user to easily grasp availability of the peripheral devices, thereby reducing useless access to the unusable peripheral devices.

### Second Embodiment

Next, a radio communication system according to a second embodiment of the invention will be described. The radio communication system of the second embodiment is different from the first embodiment in that it has a configuration comprising a radio communication apparatus 10A in place of the radio communication apparatus 10 in the radio communication system 1. The remaining configuration of the radio communication system of the second embodiment is the same as that of the radio communication system 1.

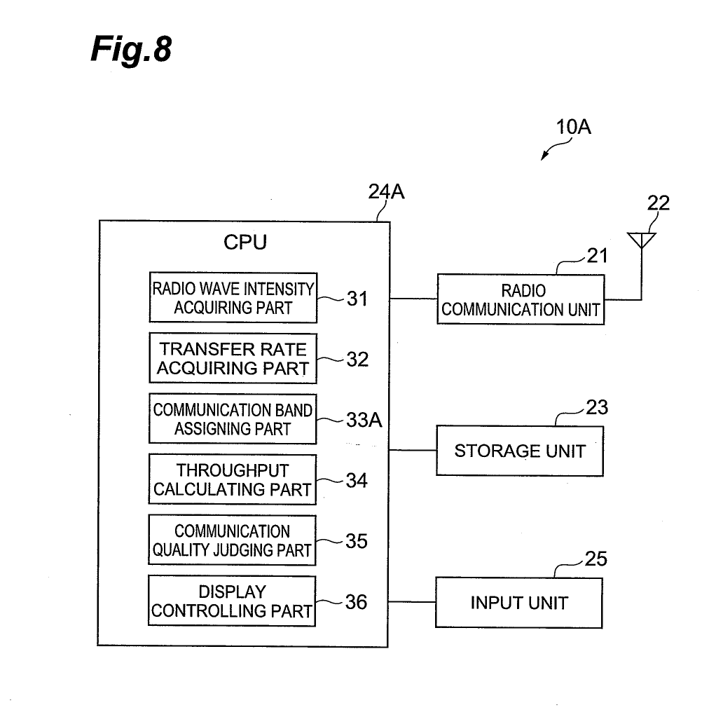

FIG. 8 is a circuit diagram showing a configuration of the radio communication apparatus 10A according to the second embodiment of the invention. The radio communication apparatus 10A shown in FIG. 8 is different from the first embodiment in that it has a configuration comprising a CPU 24A in place of the CPU 24 in the radio communication apparatus 10. In addition, the radio communication apparatus 10A further comprises an input unit 25. The remaining configuration of the radio communication apparatus 10A is the same as that of the radio communication apparatus 10.

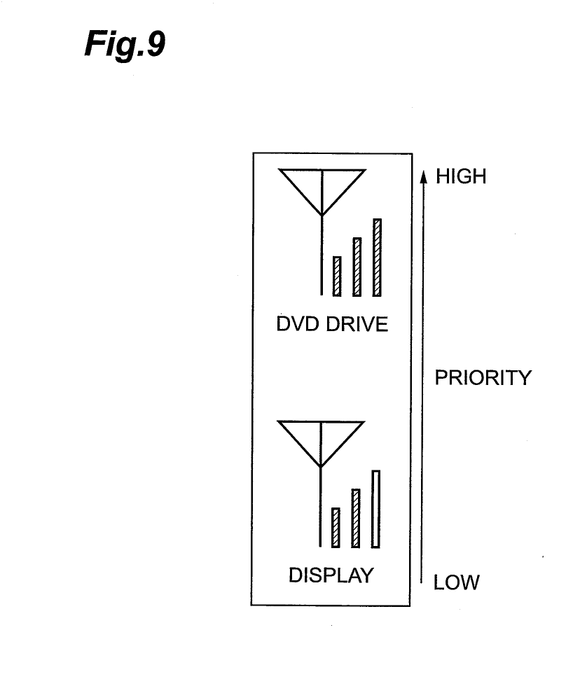

The input unit 25 is used to designate the priority or in-use/not-in-use for each of the peripheral devices in the radio communication apparatus 10A. FIG. 9 is a view showing one example of a window image on a liquid crystal display 10a when designating the priority for each of the peripheral devices. As shown in FIG. 9, the priority can be designated by the number of radio wave intensity level bars 42 similarly, for example, to the interface image. Note that the input unit 25 is, for example, a mouse, a keyboard, or the like.

The CPU 24A is different from the CPU 24 in that it functions as a communication band assigning part 33A in place of the communication band assigning part 33. The other functions of the CPU 24A are the same as those of the CPU 24.

The communication band assigning part 33A assigns a communication time and an interval i for each of the peripheral devices according to the target transfer rate Rmax acquired by the transfer rate acquiring part 32 in a decreasing order of the priority designated by the input unit 25. This allows the communication band assigning part 33A to assign the communication band (communication slot) when communicating using the TDMA system to each of the peripheral devices according to the designated priority.

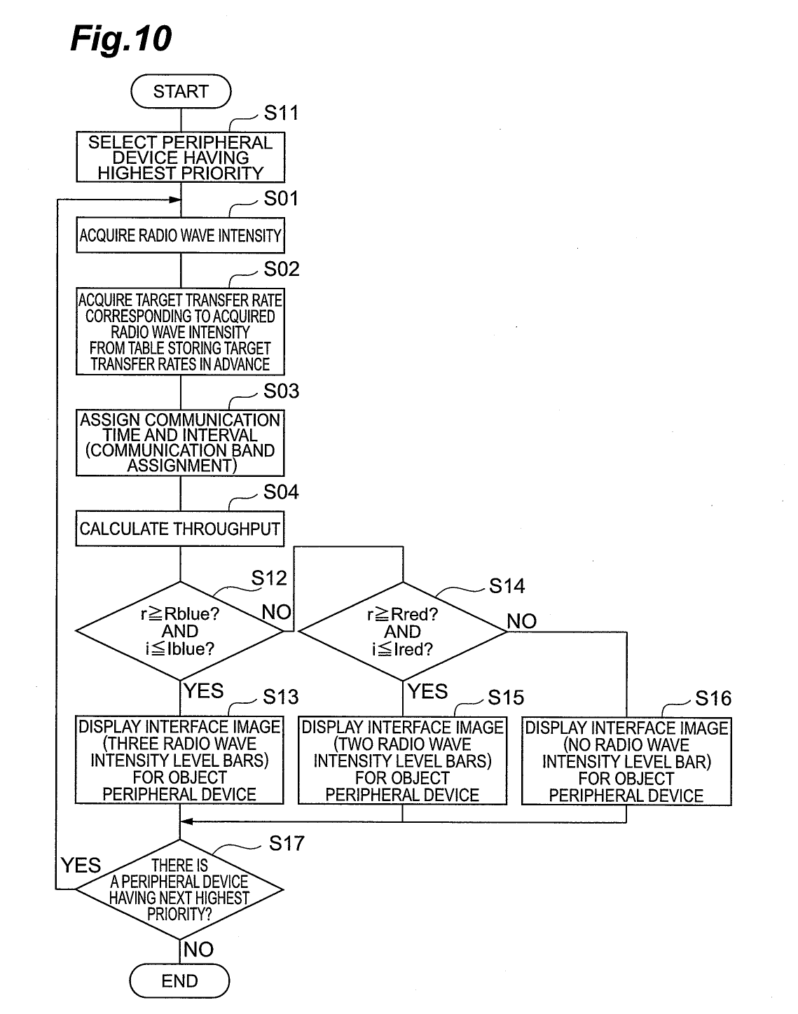

Next, the operation of the radio communication apparatus 10A will be described, and the communication quality display method for the radio communication apparatus according to the second embodiment of the invention will be described. FIG. 10 is a flowchart showing the communication quality display processing of the radio communication apparatus 10A.

First, the communication band assigning part 33A selects a peripheral device such as the display device 12 or the optical device 13 having the highest priority designated by the input unit 25 (S11), so that the processing in the above-described S01 to S04 is performed on the selected peripheral device.

The communication quality judging part 35 then compares the throughput calculated by the throughput calculating part 34 to the margin transfer rate Rblue in the third table, and compares the interval i assigned by the communication band assigning part 33A to the margin interval Iblue in the third table, to judge whether the communication time is assigned to bring the communication quality of the selected peripheral device into the normal state (S12).

If the communication time is assigned to bring the communication quality of the selected peripheral device into the normal state, the communication quality judging part 35 judges that the communication quality is in the normal state, and the display controlling part 36 displays the interface image of the object peripheral device, as the interface image indicating the normal state, in the display regions 10b on the liquid crystal display 10a (S13).

On the other hand, if the communication time is not assigned to bring the communication quality of the selected peripheral device into the normal state, the communication quality judging part 35 compares the calculated throughput to the lower limit transfer rate Rred in the second table, and compares the assigned interval i to the upper limit interval Ired in the second table, to judge whether the communication time is assigned to bring the communication quality of the selected peripheral device into the attention-required state (S14).

If the communication time is assigned to bring the communication quality of the selected peripheral device into the attention-required state, the communication quality judging part 35 judges that the communication quality is in the attention-required state, and the display controlling part 36 displays the interface image of the object peripheral device, as the interface image indicating the attention-required state, in the display regions 10b on the liquid crystal display 10a (S15). On the other hand, if the communication time is not assigned to bring the communication quality of the selected peripheral device into the attention-required state, the communication quality judging part 35 judges that the communication quality is in the communication impossible state, and the display controlling part 36 displays the interface image of the object peripheral device, as the interface image indicating the communication impossible state, in the display regions 10b on the liquid crystal display 10a (S16).

The communication band assigning part 33A then judges whether there is a peripheral device having a next highest priority (S17), and if there is one, the processing returns to S01 so that the above-described communication quality display processing is repeated on the peripheral device having the next highest priority, whereas if not, the communication quality display processing ends.

Thus, the radio communication apparatus 10A, the radio communication system, and the communication quality display method for the radio communication apparatus of the second embodiment can also present the same advantages as those of the radio communication apparatus 10 of the first embodiment.

Further, according to the radio communication apparatus 10A, the radio communication system, and the communication quality display method for the radio communication apparatus of the second embodiment, the communication time and interval can be assigned to each of the peripheral devices according to the acquired target transfer rate in the descending order of designated priority. This allows the user to easily assign the communication band to a desired peripheral device without awareness of complicated assignment such the above-described processing in S01 to S04, thus making the desired peripheral device usable and into a state with good communication quality.

Further, assignment of the communication band is not performed to the peripheral device which is set into a not-in-use state in the radio communication apparatus 10A, the radio communication system, and the communication quality display method for the radio communication apparatus of the second embodiment. Thus, the user can efficiently use the communication band only for the desired peripheral device.

Note that various modifications can be made for the invention without being limited to the above-described embodiments. For example, the radio communication system may comprise a plurality of communication apparatuses capable of data communication by radio in addition to the HUB device 11, and may comprise a plurality of peripheral devices connected to the HUB device 11. Further, the interface image in the radio communication apparatus may be a simulation image in the form of each peripheral device, and the communication quality may be distinguished by color. The radio communication apparatus, the radio communication system, and the communication quality display method for the radio communication apparatus according to a modification example will be described below.

### MODIFICATION EXAMPLE

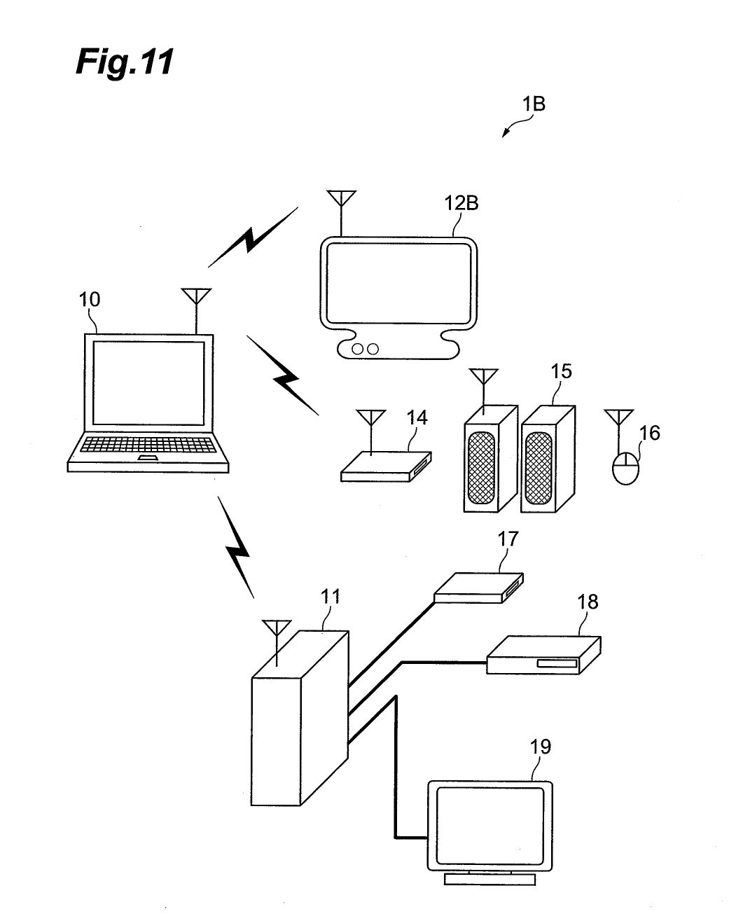

FIG. 11 is a view showing a configuration of a radio communication system according to a modification example. A radio communication system 1B shown in FIG. 11 comprises, in addition to the radio communication system 1, a display device 12B capable of data communication by radio, an optical device 14, a sound source reproducing device 15, and an input device 16. Further, in the radio communication system 1B, a storage device 17, an image recording and reproducing device 18, and a display device 19, in place of the optical device 13 in the radio communication system 1, are connected to a HUB device 11. The remaining configuration of the radio communication system 1B is the same as that of the radio communication system 1 of the first embodiment.

The display device 12B is, for example, a CRT monitor, a liquid crystal display as described above, and can perform data communication by radio with the radio communication apparatus 10 on the interface standard such as the wireless DVI and wireless HDMI.

The optical device 14 is, for example, a DVD drive or a CD drive as described above, and can perform data communication by radio with the radio communication apparatus 10 on the interface standard such as the wireless USB.

The sound source reproducing device 15 is, for example, a speaker as described above, and can perform data communication by radio with the radio communication apparatus 10 on the interface standard such as the wireless USB.

The input device 16 is, for example, a mouse, a keyboard, or the like, and can perform data communication by radio with the radio communication apparatus 10 on the interface standard such as the wireless USB.

The storage device 17 is, for example, a mobile HDD and connected to the HUB device 11 via a USB cable.

The image recording and reproducing device 18 is, for example, a DVD recorder or an HDD recorder and connected to the HUB device 11 via a cable conforming to the interface standard such as IEEE1394.

The display device 19 is, for example, a digital television and connected to the HUB device 11 via a cable conforming to the interface standard such as HDMI.

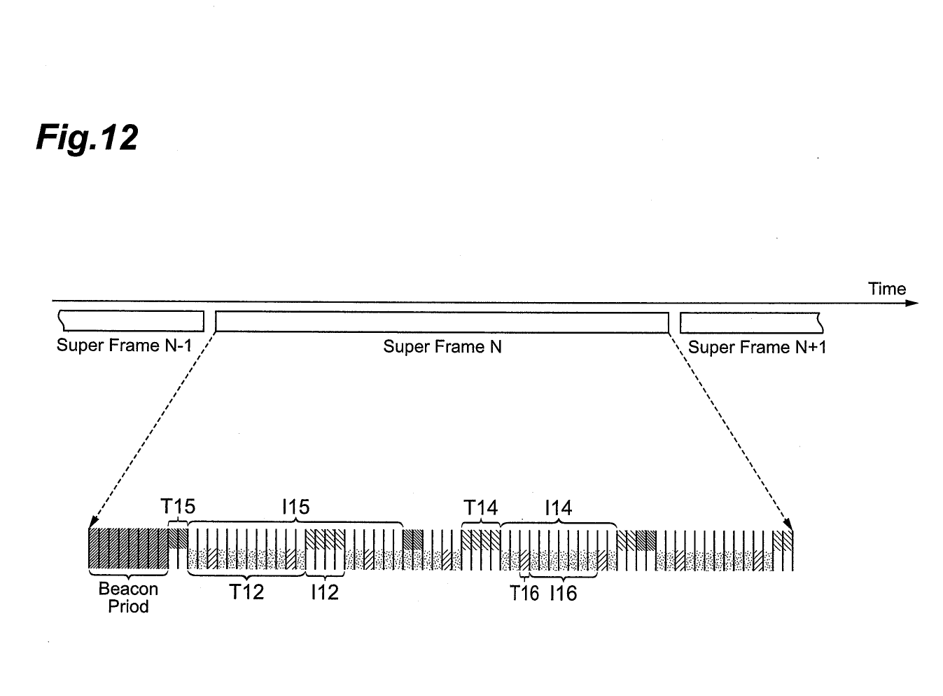

FIG. 12 is an illustration showing the communication data which has been subjected to data assignment for each of peripheral devices according to the TDMA system. As shown in FIG. 12, the communication band assigning part 33 in the radio communication apparatus 10 assigns a communication time T12 and an interval I12 for the display device 12B, a communication time T14 and an interval I14 for the optical device 14, a communication time T15 and an interval I15 for the sound source reproducing device 15, and a communication time T16 and an interval I16 for the input device 16 in one super frame according to the respective target transfer rates Rmax. This allows the communication band assigning part 33 to assign the communication band (communication slot) when communicating using the TDMA system, to each of the peripheral devices.

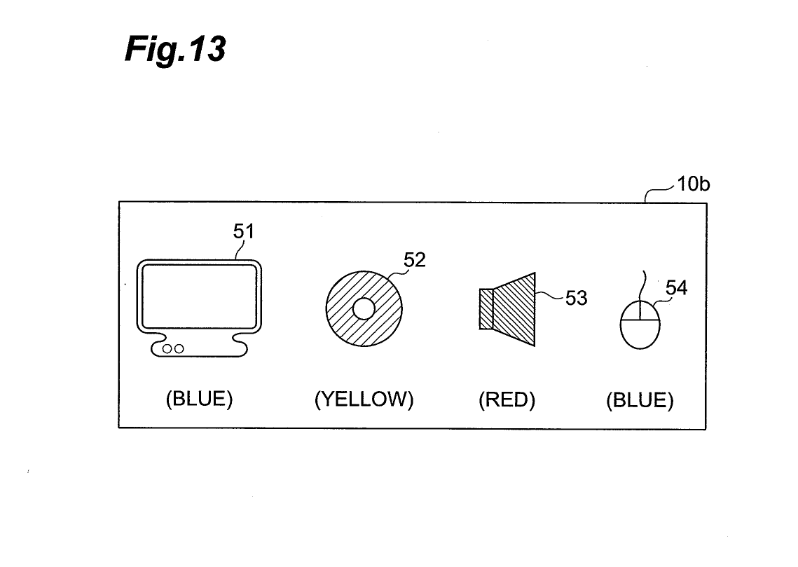

FIG. 13 is a view showing one example of the interface images according to the communication qualities. As shown in FIG. 13, the interface image is a simulation image in the form of each peripheral device and indicates the communication quality in different colors in this embodiment. For example, the display controlling part 36 displays an image simulating the form of a display as an interface image 51 of the display device 12B, an image simulating the form of a DVD medium as an interface image 52 of the optical device 14, an image simulating the form of a speaker as an interface 53 of the sound source reproducing device 15, and an image simulating the form of a mouse as an interface image 54 of the input device 16, in the display regions 10b on the liquid crystal display 10a. Further, the display controlling part 36 displays a blue interface image when the communication quality is in the normal state, displays a yellow interface image when it is in the attention-required state, and displays a red interface image when it is in the communication impossible state.

The radio communication system 1B, the radio communication apparatus, and the communication quality display method for the radio communication apparatus of this modification example can also present the same advantages as those of the first embodiment.

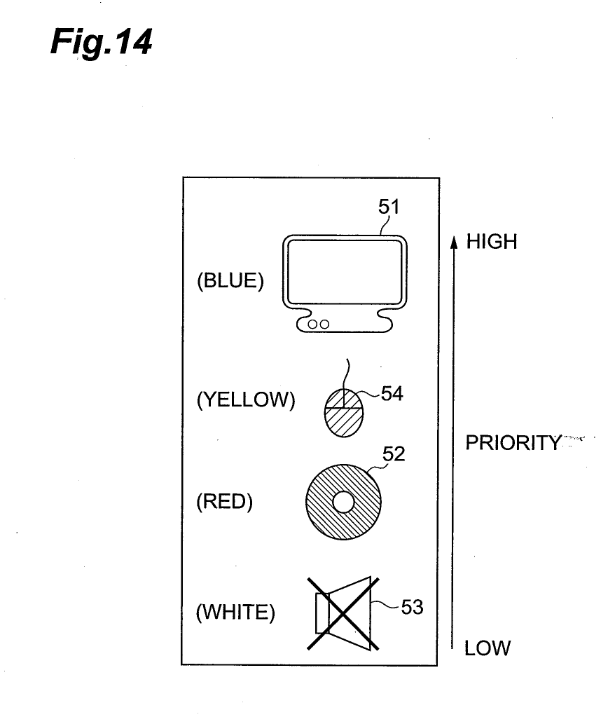

In the radio communication system 1B of this modification example, the radio communication apparatus 10A is also applicable in place of the radio communication apparatus 10 as in the second embodiment. In this case, the input unit 25 can be used to designate the priority. FIG. 14 is a view showing one example of a window image on the liquid crystal display 10a when designating the priority for each of the peripheral devices. As shown in FIG. 14, for example, the priority can be designated by color similarly to the interface image in the modification example. The radio communication system, the radio communication apparatus, and the communication quality display method for the radio communication apparatus can also present the same advantages as those of the second embodiment.

Though the communication quality is judged by comparing the throughput r to the lower limit transfer rate Rred and the margin transfer rate Rblue in the embodiments and modification example, the communication quality may be judged by comparing the assigned communication band, in place of the throughput r, to the lower limit transfer rate Rred and the margin transfer rate Rblue.

Further, though the radio wave intensity is used to judge the communication quality in the embodiments, BER or intersymbol interference level may be used.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A radio communication apparatus, comprising:
a radio communication device configured to assign communication times to a plurality of peripheral devices and to perform data communication by radio with one or more other communication apparatuses on a time-division basis;
a communication quality judging device configured to assess the communication quality for each of the peripheral devices in the data communication performed by said radio communication device with the other communication apparatuses; and
a display controlling device for displaying an interface image indicating the communication quality for each of the peripheral devices.

2. The radio communication apparatus according to claim 1, further comprising:
a communication quality data acquiring device configured to acquire, for each of the peripheral devices, communication quality data defining the communication quality in the data communication performed by said radio communication device with the other communication apparatuses,
wherein said communication quality judging device is configured to assess the communication quality for each of the peripheral devices according to the communication quality data acquired by said communication quality data acquiring device.

3. The radio communication apparatus according to claim 2, further comprising:
a first transfer rate storage device configured to store, for each of the peripheral devices, a lower limit transfer rate as a lower limit of a transfer rate necessary for the data communication; and
a second transfer rate storage device configured to store a target transfer rate of each of the peripheral devices in the data communication in association with the communication quality data,
wherein said communication quality judging device is configured to assess the communication quality by comparing the target transfer rate of each of the peripheral devices acquired from said second transfer rate storage device according to the communication quality data acquired by said communication quality data acquiring device to the lower limit transfer rate stored in said first transfer rate storage device.

4. The radio communication apparatus according to claim 2, further comprising:
a first transfer rate storage device configured to store, for each of the peripheral devices, a lower limit transfer rate as a lower limit of a transfer rate necessary for the data communication;
a second transfer rate storage device configured to store a target transfer rate of each of the peripheral devices in the data communication in association with the communication quality data;
an acquiring device configured to acquire the target transfer rate of each of the peripheral devices according to the communication quality data acquired by said communication quality data acquiring device, from said second transfer rate storage device; and
an assigning device configured to assign a communication band to each of the peripheral devices according to the target transfer rate acquired by said acquiring device,
wherein said communication quality judging device is configured to assess the communication quality by comparing the communication band for each of the peripheral devices assigned by said assigning device to the lower limit transfer rate.

5. The radio communication apparatus according to claim 2, further comprising:
a first transfer rate storage device configured to store, for each of the peripheral devices, a lower limit transfer rate as a lower limit of a transfer rate necessary for the data communication;
a second transfer rate storage device configured to store a target transfer rate of each of the peripheral devices in the data communication in association with the communication quality data;
an acquiring device configured to acquire the target transfer rate of each of the peripheral devices according to the communication quality data acquired by said communication quality data acquiring device, from said second transfer rate storage device;
an assigning device configured to assign a communication time to each of the peripheral devices according to the target transfer rate acquired by said acquiring device; and
a calculating device configured to calculate a throughput for each of the peripheral devices based on the communication time assigned by said assigning device and the target transfer rate acquired by said acquiring device,
wherein said communication quality judging device is configured to assess the communication quality by comparing the throughput for each of the peripheral devices calculated by said calculating device to the lower limit transfer rate.

6. The radio communication apparatus according to claim 4,
wherein said first transfer rate storage device is further configured to store an upper limit interval as an upper limit of an interval necessary for the data communication,
wherein said assigning device is further configured to assign an interval to the peripheral device according to the target transfer rate acquired by said acquiring device; and
wherein said communication quality assessing device is configured to assess the communication quality by comparing the communication band for each of the peripheral devices assigned by said assigning device to the lower limit transfer rate and comparing the interval for each of the peripheral devices to the upper limit interval.

7. The radio communication apparatus according to claim 5,
wherein said first transfer rate storage device is further configured to store an upper limit interval as an upper limit of an interval necessary for the data communication,
wherein said assigning device is further configured to assign an interval to the peripheral device according to the target transfer rate acquired by said acquiring device, and
wherein said communication quality assessing device is configured to assess the communication quality by comparing the throughput for each of the peripheral devices calculated by said calculating device to the lower limit transfer rate and comparing the interval for each of the peripheral devices assigned by said assigning device to the upper limit interval.

8. The radio communication apparatus according to claim 6, further comprising:
an input device configured to designate a priority for each of the peripheral devices,
wherein said assigning device is further configured to assign the communication band and the interval to the peripheral device according to the priority designated by said input device.

9. The radio communication apparatus according to claim 7, further comprising
an input device configured to designate a priority for each of the peripheral devices,
wherein said assigning device is further configured to assign the communication time and the interval to the peripheral device according to the priority designated by said input device.

10. The radio communication apparatus according to claim 1,
wherein the communication quality data includes at least any one of a bit error rate, a radio wave intensity, and an intersymbol interference level in the data communication performed by said radio communication device with the other communication apparatuses.

11. A radio communication system, comprising:
the radio communication apparatus according to claim 1; and
another communication apparatus for performing data communication relating to a plurality of peripheral devices, with said radio communication apparatus.

12. A communication quality display method for a radio communication apparatus, comprising:
assessing a communication quality for at least one peripheral device in data communication performed by a radio communication device with one or more communication apparatuses, said radio communication device configured to assign communication times to the at least one peripheral device and configured to perform data communication by radio with the other communication apparatuses on a time-division basis; and
displaying an interface image indicating the communication quality of the at least one peripheral device according to the assessed communication quality.
